(19) United States
(12) Patent Application Publication
(10) Pub. No.: US 2001/0055028 A1
(43) Pub. Date: Dec. 27, 2001

(54) METHOD, APPARATUS AND IMAGE PROCESSING SYSTEM FOR GENERATING A COMPOSITE IMAGE USING A KEY SIGNAL SUBJECTED TO IMAGE PROCESSING

(76) Inventor: MASAAKI OKA, KANAGAWA (JP)

Correspondence Address: FULWIDER PATTON LEE & UTECHT, LLP, HOWARD HUGHES CENTER, 6060 CENTER DRIVE, TENTH FLOOR, LOS ANGELES, CA, 90045, US

(21) Appl. No.: 09/097,219

(22) Filed: Jun. 12, 1998

(30) Foreign Application Priority Data
Jun. 16, 1997 (JP) P09-158881

(51) Int. Cl. G06T 11/60

(52) U.S. Cl. 345/629

(57) ABSTRACT

A key signal extracted from a first original image and the first original image are subjected to an image processing, the processed first original image and a second original image are mixed using the processed key signal to provide a new composite image of which the quality can be prevented from being effectively deteriorated.

### BACKGROUND OF THE INVENTION

1. Field of the Invention

The present invention relates to a method and apparatus for mixing a plurality of images to compose a new image, and an information processing system incorporating the method and apparatus.

2. Description of Related Art

In a graphic computer, entertainment apparatus, video apparatus, etc., a plurality of images is mixed using a mixing ratio information to compose a new image.

For composition of a new image from a mixture of a plurality of images, it has been proposed to prepare a key signal using an information called “alpha information” supplied separately from the plurality of images, and also to use as a key signal a specific pixel value included in an image.

The alpha information is a two-dimensional information having a same resolution as an image and a value ranging from 0 to 1. For example, when the resolution of an image is 640×480, the alpha information has a resolution of 640×480. Also, when bits indicating an alpha information count two in number, for example, the alpha information can take four kinds of values 0, 0.33, 0.66 and 1.0.

Assume here that a first image includes a portion having a pixel value (R1, G1, B1), and a second image includes a portion having a pixel value (R2, G2, B2) corresponding to that portion of the first image. Also assume that an alpha information for these first and second images takes a value A. Then, a pixel value of an image composed from a mixture of the first and second images is calculated as in the following:

$$\begin{matrix}\begin{matrix}A * ( R1 , G1 , B1 ) + ( 1 - A ) * ( R2 , G2 , B2 ) \\ = \{ ( A * R1 + ( 1 - A ) * R2 ) , ( A * G1 + ( 1 - A ) * G2 ) , \\ ( A * B1 + ( 1 - A ) * B2 ) \}\end{matrix} & ( 1 ) \\ \begin{matrix}A * ( R1 , G1 , B1 ) + ( R2 , G2 , B2 ) \\ = \{ ( A * R1 + R2 ) , ( A * G1 + G2 ) , ( A * B1 + B2 ) \}\end{matrix} & ( 2 ) \\ \begin{matrix} ( R1 , G1 , B1 ) + ( 1 - A ) * ( R2 , G2 , B2 ) \\ = \{ ( R1 + ( 1 - A ) * R2 ) , ( G1 + ( 1 - A ) * G2 ) , \\ ( B1 + ( 1 - A ) * B2 ) \}\end{matrix} & ( 3 )\end{matrix}$$

Next, a method of mixing two images using the above-mentioned alpha information to compose a new image will be discussed below:

FIG. 1 shows how a first image 11 and a second image 12 are mixed using an alpha information 13 supplied separately from these images 11 and 12 to generate a composite image 14.

In this example, the alpha information 13 consists of a left half 13a having a value of 0.0 and a right half 13b having a value of 1.0. Therefore, the composite image 14 generated by mixing the first and second images 11 and 12 using the alpha information 13 as a key signal consists of a left half 14a corresponding to the left half of the first image 11 and a right half 14b corresponding to the right half of the second image 12.

A pixel value of the composite image 14 is calculated using the formula (1) above. A pixel value of the left half 14a is expressed by a following relation (4a) while a one of the right half 14b is expressed by a following relation (4b).

1*(R1, G1, B1)+0*(R2, G2, B2)=(R1, G1, B1) (4a)

0*(R1, G1, B1)+1*(R2, G2, B2)=(R2, G2, B2) (4b)

FIG. 2 shows how a first image 21 and a second image 22 are mixed using a different alpha information 23 from the alpha information 13 in the above example to produce a composite image 24.

In this example, the alpha information 23 consists of a left one-third portion 23 a having a value of 0.0, a right one-third portion 23b having a value of 1, and a central one-third portion 23c having a value of 0.5.

The composite image 24 generated from the first image 21 and second image 22 mixed together using the alpha information 23 as a key signal, consists of a left one-third portion 24a resulting from a left one-third portion of the first image 21, a right one-third portion 24b resulting from a right one-third portion of the second image 22, and a central one-third portion 24c resulting from a superposition of the central one-third portion of the first image 21 and that of the second image 22.

A pixel value of this composite image 24 is calculated using the formula (1) above. A pixel value of the left one-third portion 24a of the composite image 24 is expressed by a following relation (5a), a pixel value of the right one-third portion 24b is by a following relation (5b), and a pixel value of the central one-third portion 24c is by a following relation (5c):

1*(R1, G1, B1)+0*(R2, G2, B2)=(R1, G1, B1) (5a)

0*(R1, G1, B1)+1*(R2, G2, B2)=(R2, G2, B2) (5b)

0.5*(R1, G1, B1)+0.5*(R2, G2, B2) (5c)

FIG. 3 shows an example of the configuration of an image mixing circuit adapted to mix two images using an alpha information to compose a new image. The image mixing circuit is indicated with a reference 31. It is supplied with a first image and a second image, and an alpha information which will be a key signal which defines portions of the first and second images to be mixed and a ratio at which the first and second images are mixed. According to the alpha information, the first and second images are mixed together to produce a composite image.

Mixing such two images using an alpha information in this image mixing circuit 31 will further be described later.

Next, how to generate a key signal from an image portion having a specific color to mix two images to produce a composite image from them, will be described below:

FIG. 4 schematically shows how a key signal 43 is generated from a specific color included in a first image 41 and used to mix the first image 41 and a second image 42 together to produce a composite image 44.

The first image 41 consists of a triangular portion 41a having a certain color and a portion 41b surrounding the triangular portion 41a and having a specific color, and will be a foreground of the composite image 44, and the second image 42 will form a background of the composite image 44. It includes a square portion 42b having a certain color. The key signal 43 is a signal acquired through extraction, from the first image 41, of only the portion 41b of which the pixel value provides the specific color.

The composite image 44 formed from mixing of the first and second images 41 and 42 using the key signal 43, is a superposition of the triangular portion 41a of the first image 41 on the second image 42.

FIG. 5 shows an example of the configuration of the image mixing circuit in which the key signal 43 extracted from the specific color included in the first image 41 is used to mix the first and second images 41 and 42 to form the composite image 44.

In a specific color identify circuit 51, it is judged that the pixel of the first image (original image) 41 provides a specific color, and only an image portion of which the pixel value provides the specific color is extracted to generate the key signal 43. The key signal 43 thus produced is supplied to an image mixing circuit 53.

In the image mixing circuit 53, portions of the first image (original) 41 and second image 42 that are to be mixed and a mixing ratio are determined based on the key signal 43 supplied from the specific color identify circuit 51 to produce the composite image 44 which are delivered to outside.

By any of the aforementioned image composing methods, it is possible to produce a so-called “clear void image” by superposing two images one on the other with a portion of the original image processed to have a clear color.

However, the image composing method using an alpha information is not advantageous in that a separate information from original images should be additionally used. Also, the image composing method using a key signal extracted from an image with a clear color taken as a specific color is disadvantageous in that the quality of a composite image formed from a plurality of images mixed using such a key signal is deteriorated when the original image is subjected to an image processing such a low-pass filtering.

### SUMMARY OF THE INVENTION

Accordingly, it is an object of the present invention to overcome the above-mentioned drawbacks of the prior art by providing a method and apparatus for composing a new image by mixing a plurality of images together, and an information processing system incorporating the method and apparatus, which needs no such an additional information as the alpha information and in which a composite image thus produced will not be deteriorated in quality even if an original image for the composite image is subjected to an image processing.

The above object can be accomplished by providing an image composing method in which a first image and a second image are mixed using a key information to compose a new image, comprising a key information generating step of generating a key information from a specific color of the first original image; a first image processing step of subjecting the first original image to a predetermined image processing; a second image processing step of subjecting the generated key information to the image processing; and an image mixing step of mixing the processed first image and the second original image together using the processed key information.

Also the above object can be accomplished by providing an image composing apparatus in which a first image and a second image are mixed using a key information to compose a new image, comprising means for generating a key information from a specific color of the first original image; means for subjecting the first original image and the generated key information to a predetermined image processing; and means for mixing the processed first image and the second original image together using the processed key information.

The above object is also accomplished by providing an information processing system in which an image data is generated based on a control information supplied from an input device and displayed as an image on a display unit, comprising means for generating a key information from a specific color of a first original image; means for subjecting the first original image and generated key information to a predetermined image processing; and means for mixing the processed first original image and a second original image together using the processed key information.

According to the present invention, an image composing method and apparatus, and an information processing system including the method and apparatus, are provided which needs no such an additional special information as the alpha information and in which a composite image will not be deteriorated in quality even if an original image is subjected to an image processing.

### BRIEF DESCRIPTION OF THE DRAWINGS

These objects and other objects, features and advantages of the present intention will become more apparent from the following detailed description of the present invention when taken in conjunction with the accompanying drawings, of which:

FIG. 1 schematically shows how a first image and a second image are mixed using an alpha information supplied separately from the images to compose a new image;

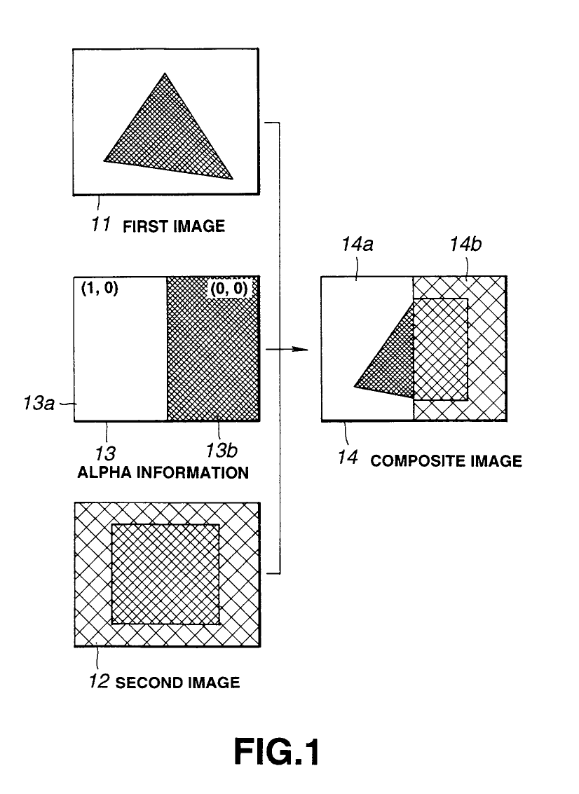

FIG. 2 schematically shows how a first image and a second image are mixed using a different alpha information from the one in FIG. 1 to produce a composite image;

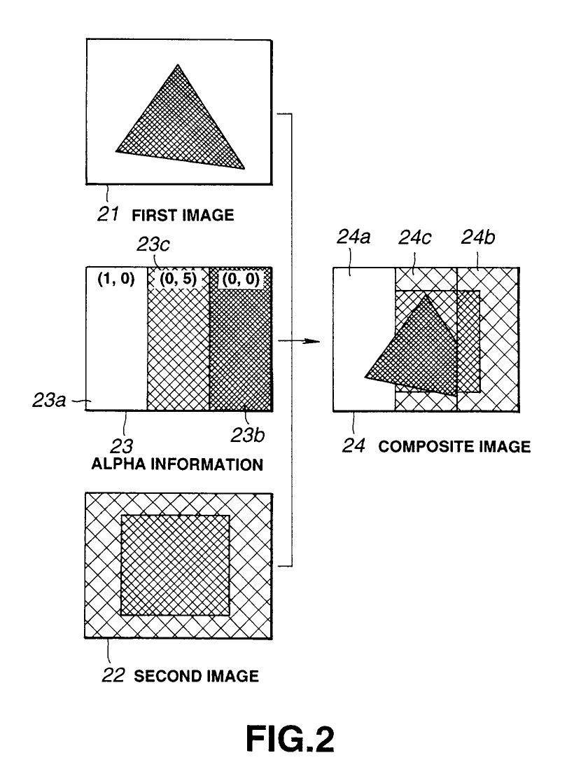

FIG. 3 is a schematic block diagram of an example of the configuration of an image mixing circuit adapted to mix two images using an alpha information to form a composite image;

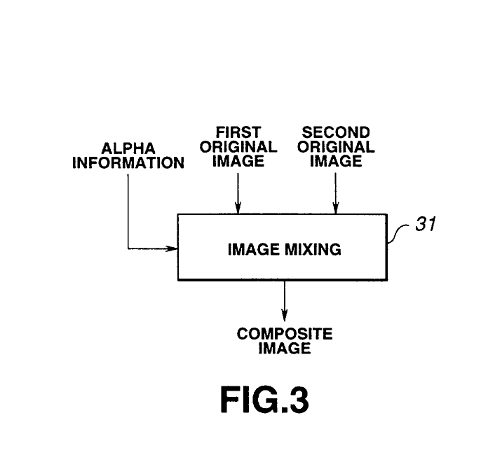

FIG. 4 schematically shows how a key signal extracted from a specific color included in a first image is used to mix the first image and a second image in order to compose a new image;

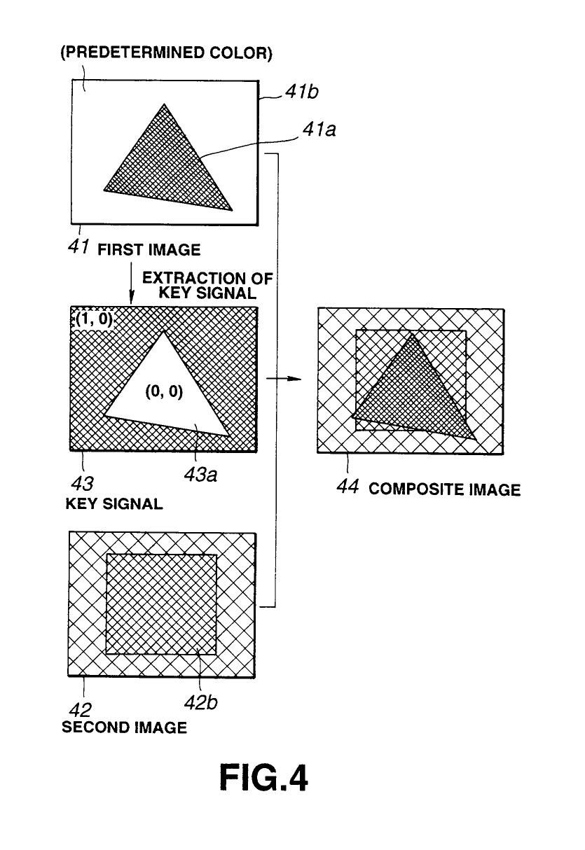

FIG. 5 is a schematic block diagram of an example of the configuration of the image mixing circuit in which a key signal extracted from a specific color included in a first image is used to mix the first image and a second image to form the composite image;

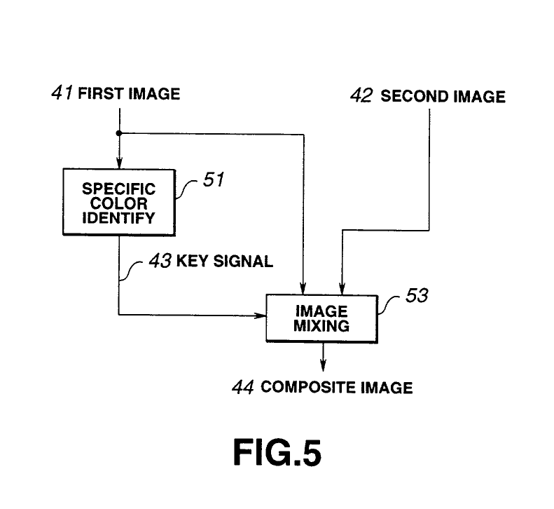

FIG. 6 schematically shows how a clear color is used as a specific color to generate a “clear void image”;

FIG. 7 schematically shows how a key signal extracted from a first image subjected to image processing is used to mix a first image and a second image to compose a new image;

FIG. 8 is a schematic block diagram of an example of the basic configuration of the image composing apparatus in which a “clear void image” is produced;

FIG. 9 shows an embodiment of the image composing method according to the present invention;

FIG. 10A is a schematic block diagram of an embodiment of the image composing apparatus according to the present invention; and

FIG. 10B is a schematic block diagram of an embodiment of the information processing system (entertainment system) according to the present invention.

### DETAILED DESCRIPTION OF THE PREFERRED EMBODIMENTS

Before proceeding the description of the embodiments of the present invention, the generation of a key signal with a clear color taken as a specific color will be described which is the base for the image composing method and apparatus, and the information processing system, according to the present invention.

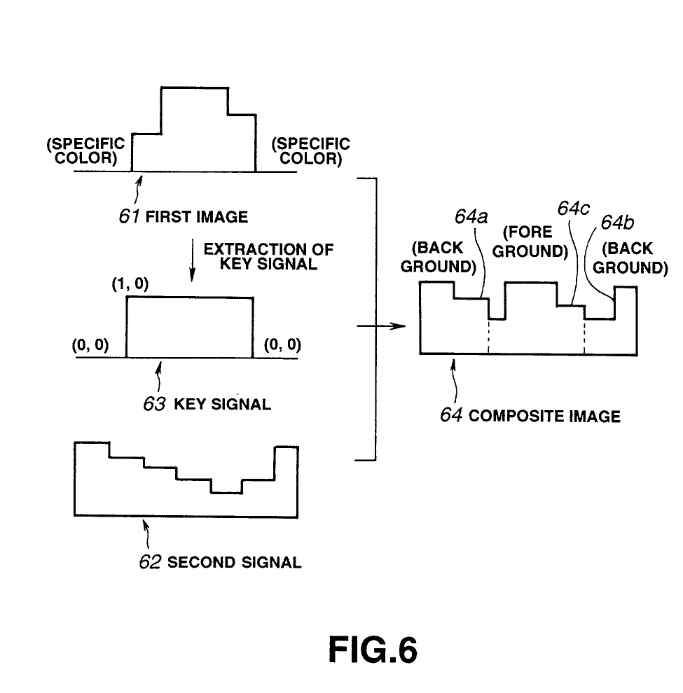

FIG. 6 schematically shows how a clear color is used as a specific color to produce a “clear void image”. For the simplicity of the illustration and description, the following description will be given using a one-dimensional graphic image will be used for the convenience of the explanation.

A first image 61 is shown which will form a foreground of a composite image 64, and a second image 62 is also shown which will be a background of he composite image 64. Also a key signal 63 is shown which provides a shift between an image being the foreground of the composite image 64 and an image being the background when a portion of the first image 61 having a specific color (of which the pixel value is 0, for example) is taken as a clear color. The key signal 63 has a value of 0.0 in the portion of the first image 64 having the specific color, and a value of 1.0 in the rest of the first image 61 having not the specific color, as will be seen from FIG. 6.

The composite image 64 is formed by mixing the first and second images 61 and 62 using the key signal 63.

However, the quality of an image composed using the first original image, if subjected to an image processing, may possibly be deteriorated as having previously been described.

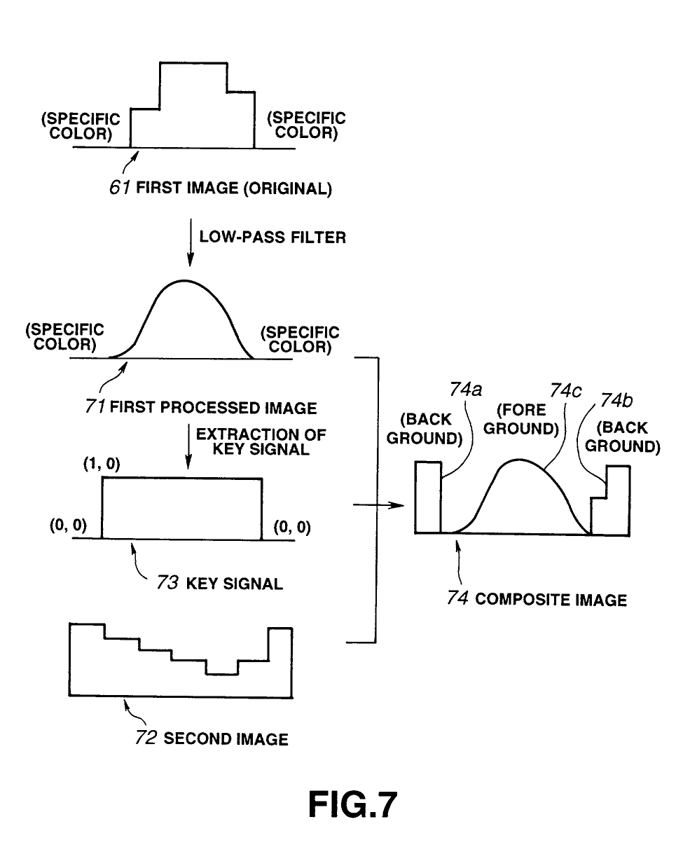

FIG. 7 schematically shows how a composite image is produced as in FIG. 6 after the first original image 61 in FIG. 6 is subjected to a low-pass filtering (will be referred to simply as “filtering” hereinafter).

In FIG. 7, a processed first image 71 is shown which will form a foreground of a composite image 74, and a second image 72 is also shown which will form a background of the composite image 74.

The processed first image 71 is a first original image 61 having been subjected to a filtering. A key signal 73 is also shown which provides a shift between the foreground image 71 of the composite image 74 and the background image 72. The key signal 73 is generated from the processed first image 71. Thus, the key signal 73 defines a portion of the processed first image 71 being the foreground of the composite image 74 and of which the pixel value provides a specific color, and the range of definition by the key signal 73 is wider than that by the aforementioned key signal 63 generated directly from the first original image 61.

The composite image 74 is an image produced by mixing the filtered first image 71 and the second original image 72 using the key signal 73.

Owing to the filtering, the first image 71 has a portion showing an intermediate pixel value nearly same as that for the specific color but not exactly any pixel value for the specific color. Thus, a portion of the composite image 74 will have a color nearly same as the specific color (clear color) which does not appear in the aforementioned composite image 64. That is to say, a key signal generated from an original image having been filtered for mixing original images will define a wrong shift point for the images which are to be mixed together, which will result in an image quality deterioration such as color bleeding, etc.

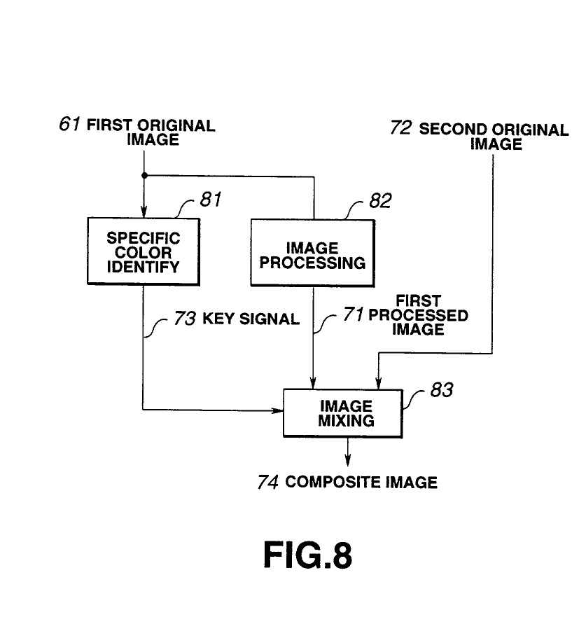

FIG. 8 is a schematic block diagram of an example of the basic configuration of the image composition apparatus in which a “clear void image” is produced according to the present invention. This image composing apparatus uses the above-mentioned clear color as the specific color.

On the assumption that the specific color is (R0, G0, B0) and the first original image has another color (R1, G1, B1). Then, the filtered first original image is expressed by a following formula:

p*(R0, G0, B0)+q*(R1, G1, B1)(p, q≠0) (6)

A composite image produced from a mixture of the processed first original image expressed by the formula (6) and a second original image having a color (R2, G2, B2) is expressed by a following formula:

$$s * \{ p * ( R0 , G0 , B0 ) + q * ( R1 , G1 , , B1 ) \} + t * ( R2 , G2 , B2 ) = S * p * ( R0 , G0 , B0 ) + s * q * ( R1 , G1 , B1 ) + t * ( R2 , G2 , B2 ) ( st \neq 0 ) \qquad ( 7 )$$

As seen from the relation (7), when the specific color (R0, G0, B0) is other than (0, 0, 0), namely, when it is not black, the specific color will bleed into the foreground and background of a composite image.

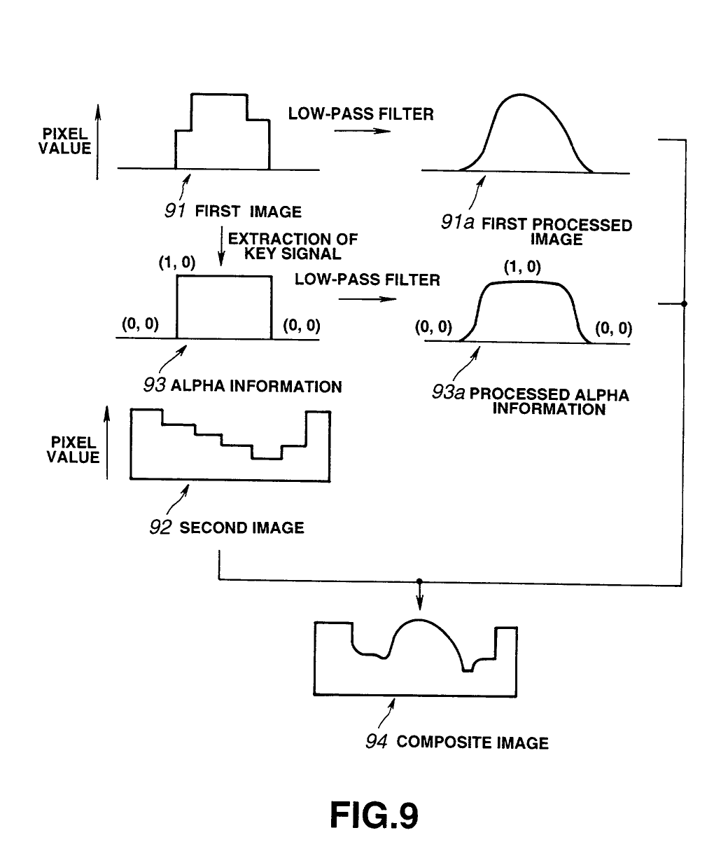

Next, preferred embodiments of the image composing method and apparatus according to the present invention, based on the image composing method and apparatus having been described in the foregoing, will be described with reference to FIG. 9.

FIG. 9 shows how to produce a “clear void image” in a preferred embodiment of the image composing method according to the present invention.

A first image (original) 91 is shown which is processed to be a processed first image 91a. For this image processing, a filtering or the like is used for a smooth joining between images.

Also an alpha information 93 is shown which is a key signal extracted from the first original image 91 on the basis of a specific color. The value of this alpha information 93 is 0 in a portion of the first original image 91 having the specific color, and 1 in the other portion of the first image 91. The alpha information 93 is subjected to a same image processing as done for the first original image 91 to provide a processed alpha information 93a.

A composite image 94 is also shown which is formed by mixing the processed first original image 91 and a second original image 92 using the processed alpha information 43a. This image composition is done using the previously mentioned formula (3).

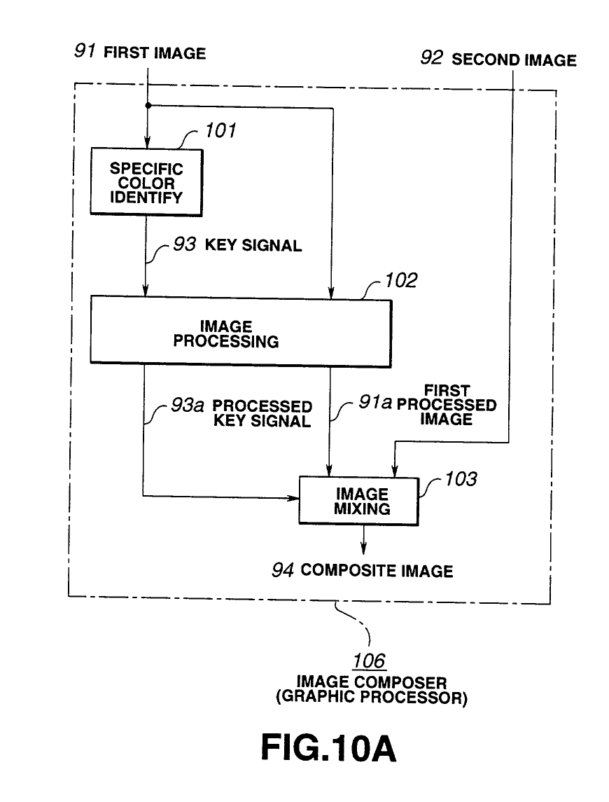

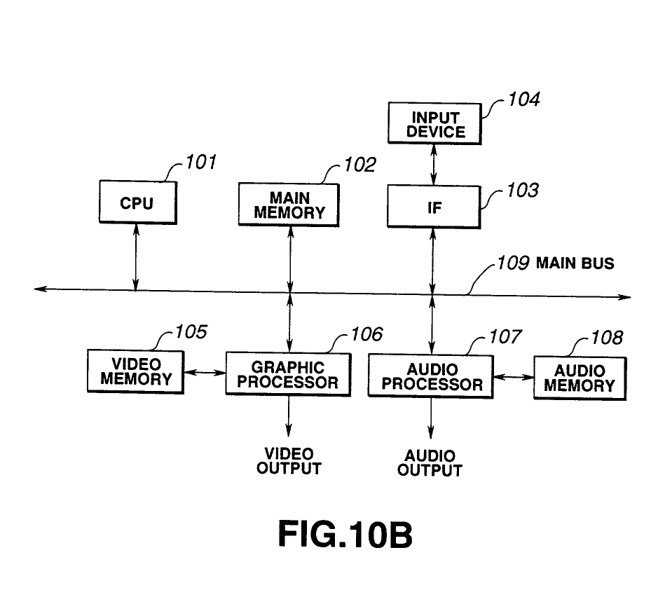

FIG. 10A is a schematic block diagram of an embodiment of the image composing apparatus adapted to carry out the aforementioned image composing method according to the present invention. It should be appreciated that the image composing apparatus of the present invention can be embodied using semiconductors, integrated circuits, discrete circuits using a plurality of transistors, or a CPU board.

A first image (original) 91 is supplied to a specific color identify circuit 101 and image processing circuit 102.

The specific color identify circuit 101 identifies a specific color of the first original image 91 to generate a key signal 93.

The image processing circuit 102 subjects the first original image 91 and key signal 93 to a same image processing. The first original image 91 thus processed is taken as a processed first image 91a, and the key signal 93 thus subjected to the signal processing is taken as a processed key signal 93a. This image processing effected here is a filtering or the like.

When each of components R, G and B of a pixel color of the first original image 91 is expressed with 8 bits, the processed key signal 93 is also extended to 8 bits. Also, the 8-bit key signal 93 is subjected, as an alpha information, to a same image processing as for each component (R, G, B) of the first original image 91 to generate the processed key information (alpha information) 93a as mentioned above. The processed first image 91a and processed key signal 93a are supplied to an image mixing circuit 103.

The image mixing circuit 103 mixes the processed first image 91a and second original image 92 together using the processed key signal 93a to form a composite image. At this time, if a pixel value (R0, G0, B0)=(0, 0, 0) is selected for a specific color, namely, if black is selected as the specific color, the previously mentioned relation (4) can be expressed in the form (8) as shown below. Further, when it is assumed that s=1 and t=1−q for using the formula (3), the relation (8) below can be expressed as a following formula (9). That is to say, only the foreground and background can be mixed.

$$s * \{ * ( 0 , 0 , 0 ) + q * ( R1 , G1 , B1 ) \} + t * ( R2 , G2 , B2 ) = s * q * ( R1 , G2 , B2 ) \qquad ( 8 )$$

=q*(R1, G1, B1)+(1−q)*(R2, G2, B2) (9)

FIG. 10B is a schematic block diagram of an embodiment of the information processing system (entertainment system) according to the present invention, incorporating the image composing apparatus having been described in the foregoing. Such an entertainment system can display a three-dimensional image with a high accuracy and at a high speed.

As shown in FIG. 10B, the information processing system or entertainment system comprises a CPU (central processing unit) 101 which calculates a vertex coordinate of a triangular area (polygon) of a displayable image to be produced, and calculates an inner product of a normal vector and light source vector from an attribute of an object and data of a light source, respectively. From the CPU 101, the vertex coordinate of the triangular area and a color information (Rg, Gg, Bg, Ag) of three vertexes of the triangle are delivered to a graphic processor (GPU) 106 as the image composing apparatus.

Further, the CPU 101 acquires control information from an input device 104 such as an input pad, joystick, etc. via an interface (I/F) 103 and main bus 109. Based on the control information thus acquired, the CPU 101 supplies a three-dimensional image information stored in a main memory 102 to the graphic processor (GPU) 106 over the main bus 109.

The graphic processor (GPU) 106 is provided to transform the three-dimensional image information supplied from the CPU 101 to an image data. It incorporates the aforementioned image composing apparatus. Thus, a three-dimensional image produced from the image data generated in the graphic processor (GPU) 106 is written into a video memory 105.

The three-dimensional image data written in the video memory 105 is read during scanning of a video signal, and displayed as a three-dimensional image on a TV monitor (not illustrated) or the like.

On the other hand, an audio or sound information corresponding to the three-dimensional image displayed and included in a scanned information extracted by the CPU 101 is supplied to an audio processor 107 which will deliver, based on the audio information supplied from the CPU 101, an audio data stored in an audio memory 108 as a sound from a speaker (not illustrated).

According to the present invention, an image comprising method and apparatus, and an information processing system, are provided in which a portion of an original image having a clear color is extracted as a key signal, the key signal is also subjected to a same image processing as for the original image, and the key signal is used in mixing the original images to form a composite image, so that no such an additional special information as the alpha information is required and the composite image thus obtained will not be deteriorated in quality even if the original image is subjected to the image processing.

What is claimed is:

1. An image composing method in which a first image and a second image are mixed using a key information to compose a new image, comprising:
a key information generating step of generating a key information from a specific color of the first original image;
a first image processing step of subjecting the first original image to a predetermined image processing;
a second image processing step of subjecting the generated key information to the image processing; and
an image mixing step of mixing the processed first image and the second original image together using the processed key information.

2. The method as set forth in claim 1, wherein the specific color is black.

3. The method as set forth in claim 1, wherein the image processing is a low-pass filtering.

4. An image composing apparatus in which a first image and a second image are mixed using a key information to compose a new image, comprising:
means for generating a key information from a specific color of the first original image;
means for subjecting the first original image and the generated key information to a predetermined image processing; and
means for mixing the processed first image and the second original image together using the processed key information.

5. The apparatus as set forth in claim 4, wherein the image processing means subjects the first original image and generated key information to a low-pass filtering.

6. The apparatus as set forth in claim 4, wherein the key information generating means takes black as the specific color.

7. An information processing system in which an image data is generated based on a control information supplied from an input device and displayed as an image on a display unit, comprising:
means for generating a key information from a specific color of a first original image;
means for subjecting the first original image and generated key information to a predetermined image processing; and
means for mixing the processed first original image and a second original image together using the processed key information.

8. The system as set forth in claim 7, wherein the image processing means subjects the first original image and generated key information to a low-pass filtering.

9. The system as set forth in claim 7, wherein the key information generating means takes black as the specific color.
